(19) United States
(12) Patent Application Publication
(10) Pub. No.: US 2015/0082215 A1
(43) Pub. Date: Mar. 19, 2015

(54) OPERATION PROCESS CREATING METHOD AND INFORMATION PROCESSING APPARATUS

(71) Applicant: FUJITSU LIMITED, Kawasaki-shi (JP)

(72) Inventors: Kazuyuki SAKAI, Nissin (JP); Kouji Abe, Kawasaki (JP)

(73) Assignee: FUJITSU LIMITED, Kawasaki-shi (JP)

(21) Appl. No.: 14/551,380

(22) Filed: Nov. 24, 2014

Related U.S. Application Data
(63) Continuation of application No. PCT/JP2012/064223, filed on May 31, 2012.

(51) Int. Cl. H04L 12/24; G06F 3/0484

(52) U.S. Cl. CPC H04L 41/22; G06F 3/04842
USPC 715/765

(57) ABSTRACT

An information processing apparatus includes a processor configured to create an operation process by executing a process. The process includes estimating, generating, and displaying. The estimating estimates trailing candidate nodes with respect to a node whose arrangement is definite, using at least one of a preset process definition, a type of node that is a manipulating target, and past creation logs of processes performed in past to create operation processes, when arranging a plurality of nodes on a screen and creating an operation process. The generating generates a display region in which a number of candidate nodes are displayed in an order, amongst the candidate nodes that are estimated. The displaying displays the display region that is generated at a position on the screen.

### CROSS-REFERENCE TO RELATED APPLICATIONS

This application is a continuation application of International Application No. PCT/JP2012/064223 filed on May 31, 2012 and designated the U.S., the entire contents of which are incorporated herein by reference.

### FIELD

The embodiments discussed herein are related to an operation process creating method, an information processing apparatus, and a computer-readable storage medium.

### BACKGROUND

There are increased demands to automatically perform most of the operation task (or activity) conventionally performed manually by a worker according to an operation manual, in order to perform the operation task of a large-scale, diversified system. Conventionally, there is a technique to create in advance an operation process (or operation flow) required to automatically perform the operation, and to operate various target servers or the like located at a data center or the like, according to the created operation process.

When creating the operation process, a dedicated developing environment (or editor) is used to select operation components (or operation manipulating components) that are suited for an operation purpose from amongst several hundred preset operation components, for example, and the selected operation components are arranged on a screen according to operation procedures. The operation components refer to various components (or parts) that perform operations such as starting a server during operation, assisting the intervening worker, or the like. Each operation component needs to be defined by a manual operation. In addition, when creating the operation process, each of the selected operation components needs to be arranged one by one on the screen, and the operation components arranged on the screen need to be linked (or connected) according to the operation procedures.

In addition, when selecting the operation components at the time of creating the operation process, there is a mechanism to display a pallet at a corner of the screen of the developing environment (or editor) that is used to create the operation process, and to arrange and display, for a user, the operation components on the pallet. Moreover, there exist conventional techniques that compare a current input pattern with past input patterns in order to extract a predicted pattern of a next input pattern, or to predict a next user input with respect to a GUI (Graphical User Interface). Furthermore, there exist conventional techniques that obtain information of each of detailed designed parts from an input design diagram, extract necessary information from a class diagram and a sequence diagram input by a designer, and judge whether a software design pattern is applicable, as proposed in Japanese Laid-Open Patent Publication No. 2-140817, Japanese National Publication of International Patent Application No. 2007-516480, and Japanese Laid-Open Patent Publication No. 2006-221293, for example.

However, in the conventional operation process creating environment, the number of predefined operation components is large, and a large number of various other kinds of components, such as components to start and end processes and components to transmit and receive Email (Electronic mail), exist in addition to the operation components. For this reason, according to the conventional techniques, it is difficult to search and quickly find various target operation components from the pallet. The conventional techniques described above use a search function based on a keyword input, however, a search result may include a large number of operation components, and a difficulty still remains in finding the target component from the search result. In addition, depending on the keyword input, the target component may be missing from the search result that is displayed, and an appropriate keyword needs to be input in order to search and find the appropriate target component. Consequently, the conventional techniques consume a large part of an operation process creating time that is required by an operation process creator (or user) in order to create the operation process.

### SUMMARY

Accordingly, it is an object in one aspect of the embodiment to provide a operation process creating method, information processing apparatus, and a computer-readable storage medium, which can quickly create the operation process.

According to one aspect of the present invention, an information processing apparatus includes a processor configured to create an operation process by executing a process including estimating trailing candidate nodes with respect to a node whose arrangement is definite, using at least one of a preset process definition, a type of node that is a manipulating target, and past creation logs of processes performed in past to create operation processes, when arranging a plurality of nodes on a screen and creating an operation process;

generating a display region in which a number of candidate nodes are displayed in an order, amongst the candidate nodes that are estimated; and displaying the display region that is generated at a position on the screen.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an operation system in one embodiment;

FIG. 2 is a diagram illustrating an example of a functional configuration of a PC (Personal Computer);

FIG. 3 is a diagram illustrating an example of a hardware configuration of the PC;

FIG. 4 is a flow chart for explaining an example of an operation process creating process in one embodiment;

FIG. 5 is a diagram illustrating an example of data for a case in which candidates are estimated based on a fixed rule;

FIG. 6 is a diagram illustrating an example of data for a case in which the candidates are estimated from an operation pair;

FIG. 7 is a flow chart for explaining an example of an accumulating process to accumulate creation logs of an operation process;

FIGS. 8A through 8D are diagrams illustrating an example of data of the creation logs of the operation process;

FIG. 9 is a flow chart for explaining an example of an estimating process in a practical example Emb1;

FIG. 10 is a diagram illustrating an example of a candidate table in the practical example Emb1;

FIG. 11 is a flow chart for explaining an example of the estimating process in a practical example Emb2;

FIGS. 12A and 12B are diagrams illustrating an example of data corresponding to the estimating process in the practical example Emb2;

FIG. 13 is a flow chart for explaining an example of the estimating process in a practical example Emb3;

FIG. 14 is a diagram illustrating an example of the candidate table in the practical example Emb3;

FIG. 15 is a flow chart for explaining an example of the estimating process in a practical example Emb4;

FIG. 16 is a diagram illustrating an example of the candidate table in the practical example Emb4;

FIG. 17 is a flow chart for explaining an example of the estimating process in a practical example Emb5;

FIGS. 18A through 18C are diagrams illustrating examples of the candidate table in the practical example Emb5;

FIG. 19 is a flow chart for explaining an example of the estimating process in a practical example Emb6;

FIG. 20 is a diagram illustrating an example of the candidate table in the practical example Emb6;

FIG. 21 is a diagram illustrating an example of a display screen in an operation process creating environment in one embodiment;

FIG. 22 is a diagram illustrating an example of the display screen in the operation process creating environment in one embodiment; and

FIG. 23 is a diagram illustrating an example of the display screen in the operation process creating environment in one embodiment.

### DESCRIPTION OF EMBODIMENTS

Preferred embodiments of the present invention will be described with reference to the accompanying drawings.

A description will now be given of an operation process creating method, an information processing apparatus, and a computer-readable storage medium in each embodiment according to the present invention.

### <Example of Operation System>

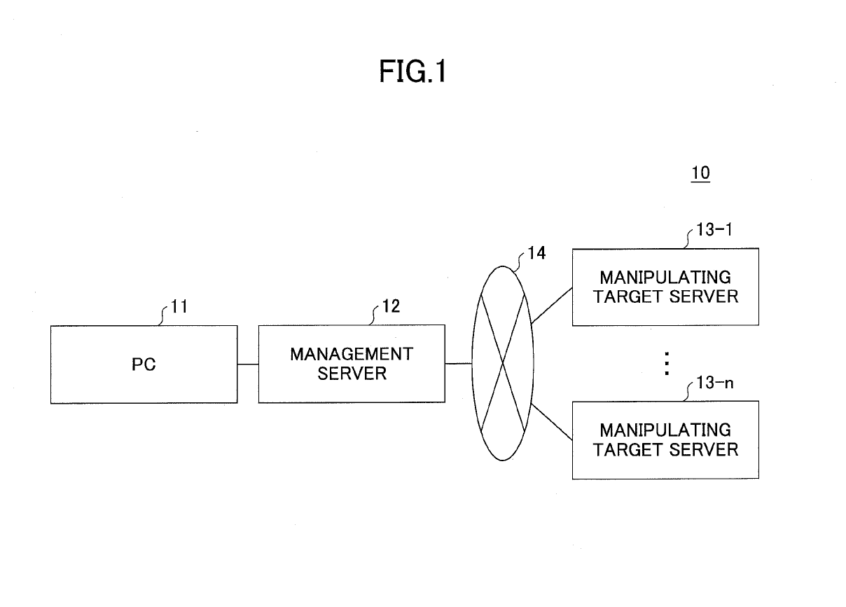

FIG. 1 is a diagram illustrating an example of an operation system in one embodiment. An operation system 10 illustrated in FIG. 1 includes a PC 11 which forms an example of an information processing apparatus, a management server 12, and one or a plurality of manipulating target servers 13-1 through 13-n (hereinafter simply referred to as “manipulating target servers 13”), where n is a natural number greater than or equal to one. In the example of the operation system 10 illustrated in FIG. 1, the management server 12 and the manipulating target servers 13 are connected and communicable via a communication network 14. Examples of the communication network 14 include a LAN (Local Area Network), the Internet, or the like. In this example, the PC 11 and the management server 12 are communicably connected, however, the connection between the PC 11 and the management server 12 is not limited to such a connection, and the PC 11 and the management server 12 may be connected to communicable via the communication network 14.

For example, the operation system 10 illustrated in FIG. 1 may, with respect to the manipulating target servers 13 that are concentrated at a data center or the like, automate operation task related to an application of each of the manipulating target servers 13, based on an operation process (or operation flow) that is created in this embodiment.

In FIG. 1, the PC 11 forms a developing environment in which the operation process is created in this embodiment. A user (or operation process creator) can register in the management server 12 the operation process created on the PC 11, for example, in order to automate the operation task using the manipulating target servers 13 or the like.

The management server 12 manages execution, execution results, or the like of the operation process to automate the operation task. In addition, the management server 12 manages configuration information, including information of the manipulating target servers 13 which are examples of the manipulating targets (or manipulating targets) that are to execute the operation process. The information of the manipulating target servers 13 may include a host name, an IP (Internet Protocol) address, a password, or the like, for example. The management server 12 also controls each manipulating target server 13 to execute a corresponding operation process, based on the configuration information described above. Further, the management server 12 outputs screens to enable confirmation of an execution state of a system manager or the like, and to enable an operation to start and stop the operation process.

The management server 12 may use a CMDB (Configuration Management Data-Base) or the like, for example. The CMDB centrally manages information of all CIs (Configuration Items) configuring an IT (Information Technology) system. By using the CMDB, the management server 12 can manage each CI (for example, hierarchical structure or the like) of the operation process in a related manner. The IT system refers to an information processing system that is configured to execute corporate activities, for example, however, the IT system is not limited to such.

The manipulating target server 13 forms a target apparatus that executes the operation process instructed by the management server 12. The manipulating target server 13 includes various kinds of apparatuses, such as an application server, or the like, for example. Transmission and reception of data between the manipulating target server 13 and the management server 12 can be made by communications employing SSH (Secure SHell), HTTP (HyperText Transfer Protocol), HTTPS (HyperText Transfer Protocol over Secure socket layer), or the like.

In the operation system 10 described above, a plurality of PCs 11 may be connected to the management server 12, so that the management server 12 can manage contents of the operation processes created by a plurality of users (or operation process creators). In addition, although the PC 11 and the management server 12 are separate, independent apparatuses in the operation system 10 described above, the PC 11 and the management server 12 may be integrated in a single apparatus. Hence, the PC 11 or the management server 12 may form an example of the information processing apparatus.

Furthermore, the information processing apparatus in this embodiment is not limited to the PC 11, and the information processing apparatus may be formed by a portable type (or mobile) communication terminal, such as a smartphone, a tablet terminal, or the like, for example.

<PC 11: Example of Functional Configuration>

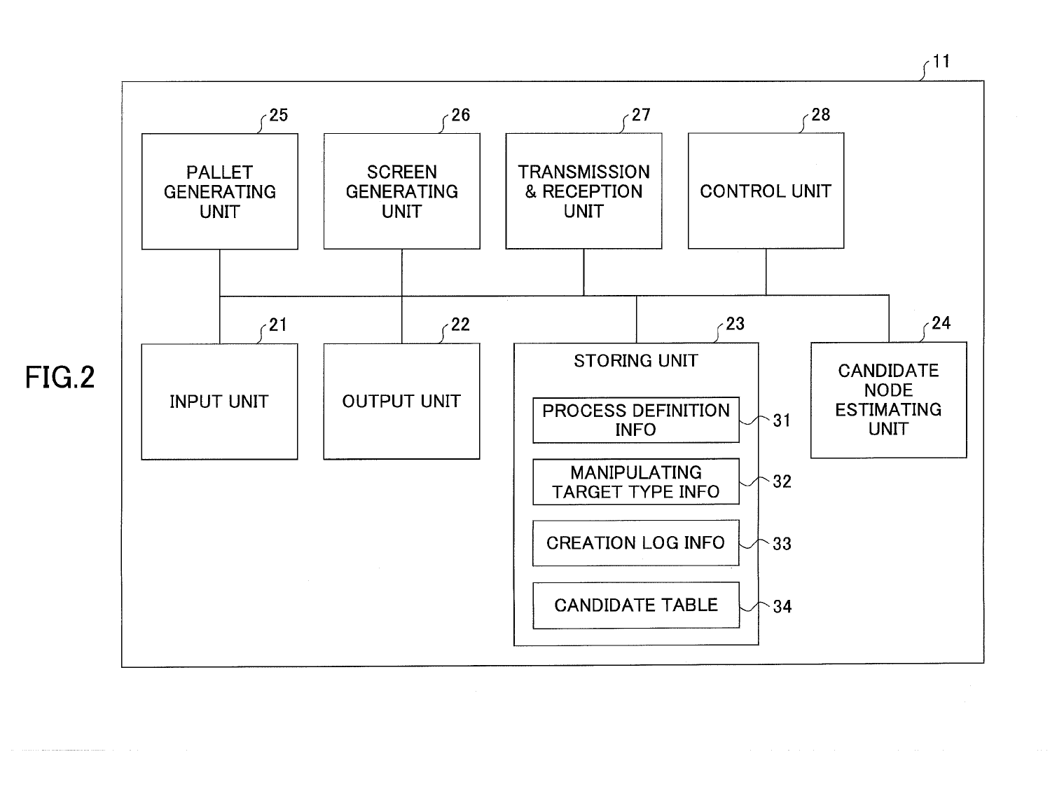

Next, a description will be given of an example of a functional configuration of the PC 11, by referring to FIG. 2. FIG. 2 is a diagram illustrating the example of the functional configuration of the PC. The PC 11 illustrated in FIG. 2 includes an input unit (or input means) 21, an output unit (or output means) 22, a storing unit (or storing means) 23, a candidate node estimating unit (or candidate node estimating means) 24, a pallet generating unit (or pallet generating means) 25, a screen generating unit (or screen generating means) 26, a transmission and reception unit (or transmission and reception means) 27, and a control unit (or control means) 28.

The input unit 21 accepts inputs from the user (or operation process creator) of the operation system 10, who uses the PC 11. The inputs include start, end, or the like of various instructions related to the operation process creating process. The input unit 21 may be formed by a keyboard, a mouse, or the like, for example. In addition, the inputs may be audio inputs or speech inputs. In this case, the input unit 21 may be formed by an audio input unit (or audio input means) or a speech input unit (or speech input means) including a microphone or the like.

The output unit 22 outputs contents input from the input unit 21, contents executed based on the input contents, or the like. The output unit 22 includes a display unit (or display means) when the contents to be output are displayed on a screen, and includes an audio output unit (or audio output means) or a speech output unit (or speech output means) including a speaker or the like when the contents to be output are output by audio or speech.

The storing unit 23 stores various kinds of information required in this embodiment. More particularly, the storing unit 23 stores process definition information 31, manipulating target type information 32, creation log information 33, and a candidate table 34.

The process definition information 31 includes information in which candidate nodes to be described later are set in correspondence with states during creation of the operation process, for example. This information included in the process definition information 31 is a preset, fixed rule. The candidate node refers to components, as a whole, that are used when creating the operation process, for example. More particularly, the candidate node not only includes components (operation components, or operation manipulating components) with respect to predetermined execution instructions (for example, start and stop) for the operation system 10, but may also include components for instructing task with respect to a person who actually performs the task based on the operation process. Further, the candidate node also includes components for starting and ending the process, components for transmitting and receiving the Email, or the like.

The process definition information 31 may include combination information of operation pairs, information of a hierarchical structure of the manipulating target, or the like. In addition, the process definition information 31 may include operation process information or the like that is registered within the operation system 10, in order to automate daily operation procedures to be performed in the operation system 10, such as in the data center or the like, for example.

The process definition information 31 further includes information for automatically executing the operation management process by calling functions of a task flow tool or an IT operation management tool within the operation system 10, if necessary. In addition, the process definition information 31 includes information for automatically executing the operation management process by using various management tools for setting the server or a storage, backup, or the like.

The manipulating target type information 32 includes information for acquiring a type of the manipulating target that is being created from a prearranged node (or leading node), or the like.

The creation log information 33 includes log information, such as data logs, manipulation logs, or the like, of operation process creating processes performed by the user in the past, for example. The creation log information 33 may statistically store the log information of the operation process creating processes performed by a plurality of users. In addition, the creation log information 33 may include time information, for example. Further, the creation log information may include frequency of use (or number of times used) for each node within a predetermined time.

The candidate table 34 in this embodiment includes information of estimated candidate nodes. More particularly, the candidate table 34 includes information of a component group (or group of components) displayed in the pallet on the screen of the developing environment (or editor) during the operation process creating process, for example. In addition, the candidate table 34 not only includes the operation components, but may also include nodes, such as components for instructing task to a person, components for starting and ending processes, components for transmitting and receiving the Email, or the like.

The storing unit 23 may store information other than the information described above. The storing unit 23 may store various setting information or the like for executing processes of this embodiment, for example. In addition, the storing unit 23 can read the stored, various kinds of information at predetermined timings, if necessary, and write execution results or the like related to the operation process creating process. The storing unit 23 is a collection of the various kinds of information described above, and the storing unit 23 may have functions of a hierarchically configured database so that the information can be searched and extracted using a keyword or the like, for example.

The candidate node estimating unit 24 estimates a candidate of a node trailing (or is subsequent to) a node (for example, various components including an operation component, a component for instructing task, components for starting and ending, components for transmitting and receiving Email, or the like) which is already definite in the operation process that is currently being created. More particularly, the candidate node estimating unit 24 estimates the candidate node trailing the already definite node, using at least one of the process definition being created, the type of node that is the manipulating target, the past creation logs, or the like. An example of the candidate node that is estimated by the candidate node estimating unit 24 will be described later. In addition, information of the estimated candidate node may be stored in the storing unit 23, or may be output to the pallet generating unit 25.

The pallet generating unit 25 generates the pallet for displaying contents of one or a plurality of nodes estimated by the candidate node estimating unit 24 at a predetermined position in an operation process creating screen. The pallet exists in an editor screen or the like of the operation process creating environment, for example, and forms a display region for displaying a predetermined number of candidate nodes. In other words, the pallet generating unit 25 forms an example of a display region generating unit (or display region generating means). In this embodiment, the pallet generating unit 25 may generate a display region (for example, another window screen) other than the pallet, for example.

In this embodiment, the user selects a trailing node from at least one candidate node arranged in the pallet, and the selected trailing node is arranged at a predetermined position on the screen in order to create the operation process. In addition, the selection, arrangement, or the like of the node by the user can be made by moving a cursor on the screen using the input unit 21, such as the mouse, for example. The cursor is a kind of a pointer that is displayed in the display region of the screen, and determines a positional move or a position when manipulated by the user.

Furthermore, the pallet generating unit 25 adjusts the arrangement, the display position, the number, or the like of plurality of nodes displayed within the pallet. Hence, this embodiment can provide the user with the candidate nodes having a high possibility of being used.

The screen generating unit 26 generates a developing environment (or editor) screen for creating the operation process in this embodiment, an input screen for inputting various kinds of setting information, a screen for displaying contents of the created operation process, or the like. The nodes that are displayed in the developing environment (or editor) screen that is generated by the screen generating unit 26 may be displayed in the form of an icon, a name, or the like set for each of the nodes. In addition, the nodes that are displayed in the developing environment (or editor) screen may be displayed in the form of a symbol, a pattern, a mark, a character string, or the like set for each of the nodes.

The screen generating unit 26 also sets the display position of the pallet on the screen, wherein the pallet is generated by the pallet generating unit 25 and the one or plurality of candidate nodes are arranged in the pallet. The screen generating unit 26 sets the display position of the pallet based on position information of the cursor on the screen or based on position information of the node that is arranged last, for example. More particularly, the screen generating unit 26 sets the display position of the pallet in a vicinity of the cursor manipulated by the user on the screen. The display position of the pallet is set in the vicinity of the cursor because the position where the trailing node is to be arranged has a high possibility of being in the vicinity of the node that is arranged last, and the position of the cursor manipulated by the user also has a high possibility of being in the vicinity of the node that is arranged last. Hence, distances separating the cursor, the pallet, and the trailing node can be made short, in order to reduce a moving distance and a moving time of the cursor that is manipulated by the user, and to reduce a load on the user to manipulate the cursor or the like.

The screen generating unit 26 can set the display position of the pallet generated by the pallet generating unit 25 using the position information of the nodes already arranged on the screen, for example. In this case, the screen generating unit 26 sets the display position of the pallet generated by the pallet generating unit 25 to a position that does not overlap the nodes that are already arranged on the screen, for example. Hence, in this embodiment, it is possible to prevent the nodes already arranged on the screen from becoming concealed (or hidden) by the pallet that is displayed. When displaying the pallet, the node that is already arranged on the screen may become concealed due to size relationships or the like of the screen, the nodes, and the pallet. For this reason, in a case in which a plurality of nodes are already arranged on the screen, this embodiment preferably displays the pallet so that the older nodes become concealed by the pallet first. The older nodes refer to the nodes that are already displayed for a long time after being arranged on the screen. Accordingly, this embodiment can prevent the node from becoming concealed by the pallet immediately after this node is arranged on the screen, and prevent the pallet from being displayed in a region in which a next node has a high possibility of being arranged.

The display position of the pallet is not limited to the display positions described above. For example, the display position of the pallet may be set, based on the position information of the cursor and the position information of the nodes that are already arranged on the screen. The screen generated by the screen generating unit 26 is displayed on the output unit 22, such as the display unit.

The transmission and reception unit 27 may form a communication interface capable of transmitting and receiving information required by each process executed in this embodiment, an execution program (for example, an operation process creating program) to execute the operation process creating process, or the like. In addition, the transmission and reception unit 27 may transmit various kinds of execution results or the like of processes executed by the PC 11 to an external apparatus such as the management server 12.

The control unit 28 controls the entire PC 11. For example, the control unit 28 controls at least one of estimating the candidate nodes, generating the pallet, generating the screen, transmitting and receiving, or the like.

<PC 11: Hardware Configuration>

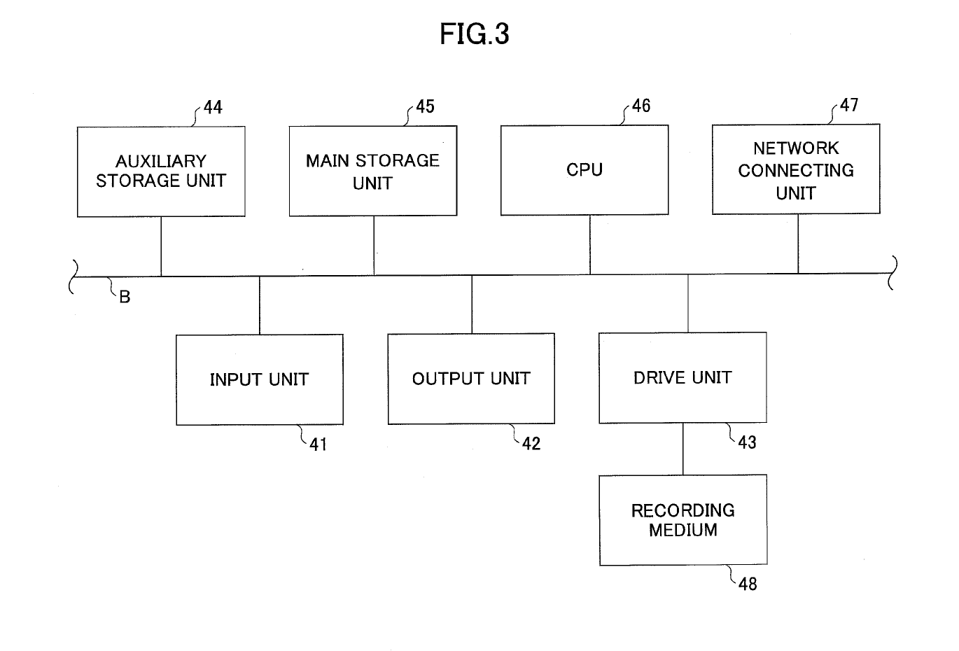

Next, a description will be given of an example of a hardware configuration of the PC 11, by referring to FIG. 3. FIG. 3 is a diagram illustrating the example of the hardware configuration of the PC. The PC 11 illustrated in FIG. 3 includes an input unit 41, an output unit 42, a drive unit 43, an auxiliary storage unit 44, a main storage unit 45, a CPU (Central Processing Unit) 46 to perform various kinds of control, and a network connecting unit 47 that are mutually connected via a system bus B.

The input unit 41 includes the pointing device, such as the keyboard and the mouse, to be manipulated by the user of the PC 11, for example. Various operation signals instructing execution of programs or the like, are input by the user from the input unit 41.

The output unit 42 includes the display unit for displaying various windows, data, or the like required to operate the PC 11 in order to perform the processes of this embodiment. The display unit of the output unit 42 displays histories, logs, results, or the like of control programs executed by the CPU 46.

The execution program (or operation process creating program) that is installed in the PC 11 may be provided by a recording medium 48 or the like, for example. The drive unit 43 reads various kinds of data, including the execution program or the like recorded in the recording medium 48. In other words, the recording medium 48 can be set (or loaded) in the drive unit 43, and the execution program recorded in the recording medium 48 can be installed in the auxiliary storage unit 44 via the driver unit 43. In a case in which the recording medium 48 set in the drive unit 43 is a writable recording medium, the data, including the results of executing the programs, can be written to the recording medium 48.

The auxiliary storage unit 44 may be formed by a storage unit (or storage means) such as an HDD (Hard Disk Drive), an SDD (Solid State Drive), or the like. In this embodiment, the auxiliary storage unit 44 stores the execution program, the control program, or the like, and the data input and data output (or data write and data read) to and from the auxiliary storage unit 44 may be performed if necessary.

The main storage unit 45 stores the execution program or the like read from the auxiliary storage unit 44 by the CPU 46. The main storage unit 45 may be formed by a ROM (Read Only Memory), a RAM (Random Access Memory), or the like, for example.

The CPU 46 is an example of a processor that controls the processes of the PC 11, including various computations and data input and data output with respect to the hardware constituent elements, based on the control program such as an OS (Operating System), and the execution program stored in the main storage unit 45, in order to perform the processes of the operation process creating process. The various information or the like required during execution of the program may be acquired from the auxiliary storage unit 44 or the like by the CPU 46. In addition, the execution results or the like may be stored in the auxiliary storage unit 44 or the like by the CPU 46.

The network connecting unit 47 forms a communication interface to connect to the management server 12 and enable data transmission and reception between the PC 11 and the management server 12. The network connecting unit 47 can also connect to the management server 12 and acquire the execution program and the various kinds of data, and provide with respect to the management server 12 the execution results that are obtained by executing the program or the execution program itself corresponding to this embodiment. In this embodiment, the PC 11 may transmit and receive the various kinds of data with the manipulating target server 13, by connecting to the manipulating target server 13 via the network connecting unit 47.

The recording medium 48 may be formed by a non-transitory computer-readable storage medium that stores the execution program or the like, as described above. For example, the recording medium 48 may be formed by a portable recording medium such as a USB (Universal Serial Bus) memory, a CD-ROM (Compact Disk-Read Only Memory), a DVD (Digital Versatile Disk), or the like, or by a semiconductor memory such as a flash memory or the like.

<Example of Operation Process Creating Process>

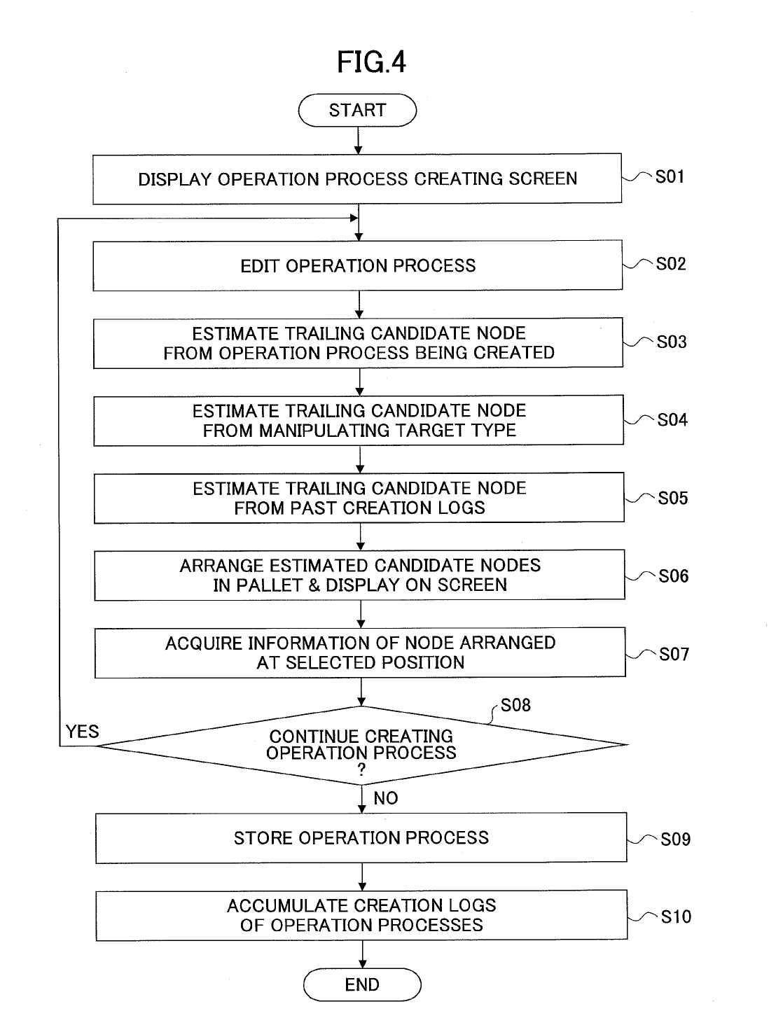

Next, a description will be given of an example of the operation process creating process in this embodiment, by referring to FIG. 4. FIG. 4 is a flow chart for explaining the example of the operation process creating process in one embodiment. In the example illustrated in FIG. 4, the operation process creating process first displays the operation process creating screen in response to an execution instruction from the user, for example (step S01), and edits the operation process (or operation flow) according to the arrangement of the nodes or the like instructed by the user using the displayed screen (step S02).

Then, the operation process creating process estimates the trailing candidate node from the operation process that is being created (step S03). In addition, the operation process creating process estimates the trailing candidate node from the type of manipulating target (step S04). Further, the operation process creating process estimates the trailing candidate node from the past creation logs (step S05). The operation process creating process in this embodiment may perform at least one of steps S03 through S05 described above, and the order of steps S03 through S05 is not limited to the order illustrated in FIG. 4, and steps S03 through S05 may be performed in any order.

Next, the operation process creating process arranges the estimated candidate node in the pallet, and displays the pallet including the estimated candidate node (step S06). In this example, the pallet that includes the estimated candidate node and is displayed in step S06 is arranged at the predetermined position on the screen, as described above. The predetermined position may be in a vicinity of the node that is arranged last in the screen, a vicinity of the cursor manipulated by the user, a position not overlapping the nodes already arranged in the screen, or the like. However, the predetermined position is not limited to such positions.

The operation process creating process acquires the information of the candidate node that is selected by the user from the candidate nodes arranged in the pallet displayed by the process of step S06, and is arranged at the predetermined position (step S07). Next, the operation process creating process judges whether to continue creating the operation process (step S08), and the process returns to step S02 when the operation process creating process is to be continued and the judgment result in step S08 is YES. On the other hand, when the operation process creating process is to be ended and the judgment result in step S08 is NO, the operation process creating process stores the created operation process (step S09), accumulates the creation logs of the operation process (step S10), and the process ends.

<Example of Estimating Process in Candidate Node Estimating Unit 24>

Next, a description will be given of an example of the estimating process of the candidate node estimating unit 24 described above. The candidate node estimating unit 24 estimates the candidate of the node (for example, trailing node) to be arranged next to the already definite node (for example, leading node), using at least one of the process definition being created, the type of the manipulating target, and the past creation logs. Examples of such estimation of the candidate node are described below.

<(1) Estimating Candidate From Process Definition Being Created>

In this embodiment, the candidate is estimated by estimating the candidate according to a fixed rule that is predefined in the process being created, estimating the candidate from the operation pair, estimating the candidate by taking into consideration manipulations successively made on the same target, or estimating the target by taking into consideration the hierarchical structure of the manipulating target. In this embodiment, the candidate node is estimated using at least one of the above described techniques to estimate the candidate. A description will be given below of the techniques to estimate the candidate.

<(a) Estimating Candidate According to Fixed Rule>

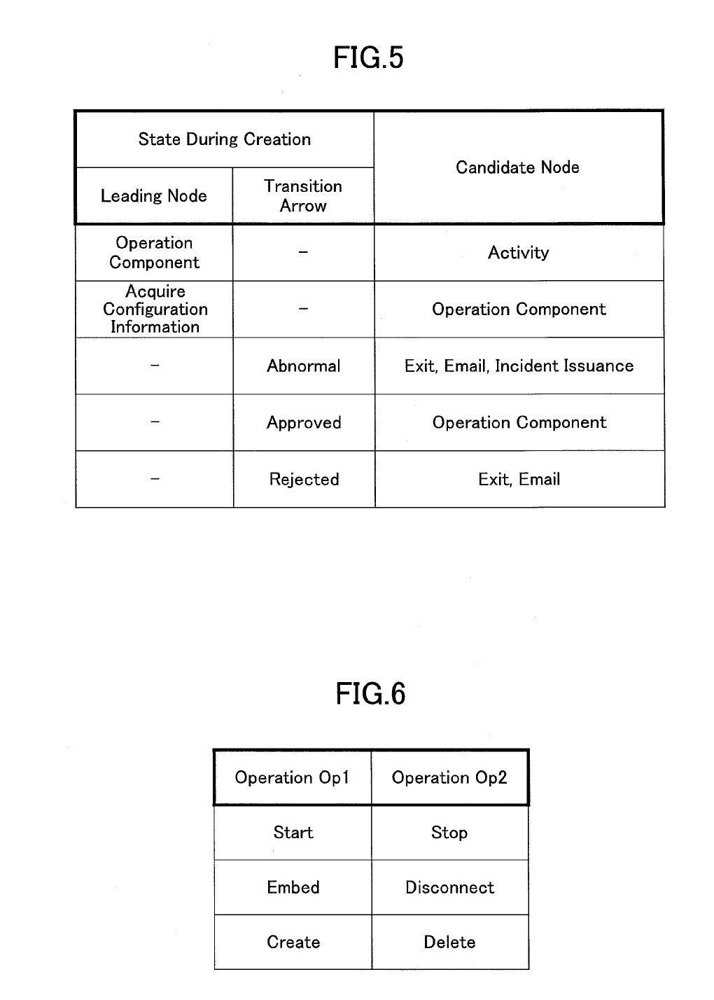

FIG. 5 is a diagram illustrating an example of data for a case in which the candidates are estimated based on the fixed rule. The fixed rule is included in the manipulating target type information 32 described above. When estimating the candidate based on the fixed rule, the candidate node to be arranged is estimated from the state during creation of the operation process illustrated in FIG. 5 and the corresponding relationship to the trailing node. Items of the fixed rule illustrated in FIG. 5 include a “state during creation”, a “candidate node”, or the like, however, the fixed rule is not limited to such. In addition, the state during creation includes information related to the leading node (or preceding node) whose arrangement is already definite, and a transition arrow (or linking line) linking the leading node and the trailing node.

For example, in a case in which an operation component node is arranged as the leading node in FIG. 5, an “activity” is estimated as the candidate node. The estimated “activity” refers to a component indicating a task instruction with respect to a person actually executing the operation task based on the operation process, for example. In addition, in a case in which the configuration information related to the leading node is acquired, a related “operation component” is estimated as the candidate node.

Moreover, in a case in which an abnormal route is being created, “exit (for example, process end)”, “Email (for example, Email transmission)”, or “incident issuance (for example, transmit a notification signal to a target person via a predetermined management tool)” is estimated as the candidate node. The abnormal route, an approved route, and a rejected route illustrated in FIG. 5 can be comprehended from the contents of the transition arrow (or linking line) linking the nodes, for example. The candidate node may also be estimated from the transition arrow.

Hence, in this embodiment, a plurality of candidate nodes can be set with respect to one state that is being created. The type and contents of the fixed rule are not limited to those illustrated in FIG. 5.

<(b) Estimating Candidate From Operation Pair>

FIG. 6 is a diagram illustrating an example of data for a case in which the candidates are estimated from the operation pair. Items of the data of the operation pair illustrated in FIG. 6 include “operation Op1” and “operation Op2”, however, the items are not limited to such. In the example illustrated in FIG. 6, the operation pair is predefined between two nodes, and when one of the two nodes is arranged, the other of the two nodes is estimated as the candidate node.

More particularly, in the relationship of the operation Op1 and the operation Op2 illustrated in FIG. 6, a “stop” operation forms a pair with a “start” operation, a “disconnect” operation forms a pair with an “embed” operation, and a “delete” operation forms a pair with a “create” operation. In this embodiment, after the “stop” operation of a service, an operation such as a backup may be performed, and there is a possibility of thereafter performing the “start” operation of a service. In addition, in this embodiment, after the “disconnect” operation from a load distributing apparatus or the like, for example, a certain operation such as applying a patch may be performed, and there is a possibility of thereafter performing the “embed” operation to the load distributing apparatus or the like. Moreover, in this embodiment, after the “create” operation of a file, for example, there is a possibility of performing the “delete” operation at a latter process to delete the created file. Accordingly, this embodiment can estimate the appropriate candidate node by presetting the operation pairs such as those described above.

<(c) Estimating Candidate By Considering Operations Successively Performed on Same Target>

When performing an operation on a specific apparatus in this embodiment, there is a high possibility of successively making a plurality of manipulations that are the same. Hence, in this embodiment, the candidate node is estimated by regarding an operation node that makes the manipulation on the same target as an operation component that is already arranged, as a trailing node.

In the case of a “stop service”, for example, the nodes for making the manipulation on the same target, such as “apply patch to server”, “restart service”, and “confirm service state”, are estimated as the candidate nodes and displayed. Similarly, in the case of a “confirm existence of file”, for example, the nodes for making the manipulation on the same target, such as “transfer file” and “delete file”, are estimated as the candidate nodes and displayed.

<(d) Estimating Candidate By Considering Hierarchical Structure of Operation Target>

In this embodiment, the operation may be performed in an order according to the hierarchical structure of the configuration items. Accordingly, in this embodiment, the operation component to be arranged as a trailing node is proposed based on the order of the hierarchical structure.

The hierarchical structure may be obtained from a 1:N relationship using the relationships of the CIs (Configuration Items) in the CMDB (Configuration Management Data-Base) of the management server 12. For example, the hierarchical structure can be derived from the 1:N relationship such as “N applications exist in one service” and “N services exist in one server”, however, the 1:N relationship is not limited to such. In this embodiment, the operation components are estimated to be arranged as “stop application→stop service→stop server” based on the hierarchical structure such as “application>service>server”.

<(2) Estimating Candidate From Type of Manipulating Target>

In this embodiment, the operation component to be arranged next can be estimated from the type of the manipulating target, for example. More particularly, in this embodiment, the candidate node can be estimated from the manipulating target (for example, host name, service, or the like) of the input parameter of the operation component that is already arranged. In addition, in this embodiment, the candidate node can be estimated from the search result or the like of the component that is searched at the time of creating the operation process, for example. In this case, the configuration information corresponding to the manipulating target may be searched from the CMDB, and the type of the manipulating target may be specified, in order to estimate the operation component corresponding to the specified type of the manipulating target as the candidate. Further, in this embodiment, the candidate may also be estimated from “apparatus type (server, PC, network apparatus)”, “software type (cluster, application server, virtual server)”, “file, directory, or the like”, “type of OS”, or the like, for example.

<Estimating Candidate From Past Creation Logs>

In addition, in this embodiment, when estimating the candidate from the past creation logs, the past logs at the time of developing the operation process may be stored, and the trailing node such as the operation component can be estimated based on the stored logs. The log information may include the number of times the operation component is used, the relationship of the operation component node with respect to adjacent nodes, the set of operation components, or the like, however, the log information is not limited to such.

<(a) Number of Times Operation Component is Used>

In this embodiment, the operation components having a high frequency of use (or number of times used) in the past are displayed with a priority over other operation components with lower frequency of use. In addition, this embodiment may use the log information, such as the “relationship of the operation component node with respect to the adjacent nodes”, to determine the priority with which the operation components are to be displayed. In this case, it is possible to obtain from the log information the type of operation component that has a high possibility of being arranged as a trailing component with respect to the operation component that is already arranged, and display the operation component having the high possibility of being arranged as the trailing component with a priority over other components having a lower possibility of being arranged as the trailing component.

<(b) Set of Operation Components>

In this embodiment, the candidate node may be estimated using a set of operation components that are often used simultaneously, based on the log of past operation process creating processes. For example, this embodiment obtains the set to which the operation component that is already arranged at the time of creating the operation process belongs, and displays the obtained operation component with a priority over other components not belonging to the set.

When displaying the candidate nodes, the candidate nodes may be displayed in an order starting from the candidate node estimated from the state of the process definition being created, then the candidate node estimated from the type of the manipulating target, and then the candidate node estimated from the past creation logs, for example. However, the order in which the candidate nodes are displayed is not limited to such.

As described above, this embodiment can easily find the operation component that is to be arranged in the operation process. More particularly, when creating the operation process, the operation component to be arranged next can be displayed automatically (without using a filtering function), and it is possible to efficiently find the operation component to be arranged next. In addition, because a pop-up display of the pallet can be made at the predetermined position on the editor, it is easy to select the operation component. As a result, this embodiment can quickly create the operation process.

<Step S10: Accumulating Process to Accumulate Creation Logs of Operation Process>

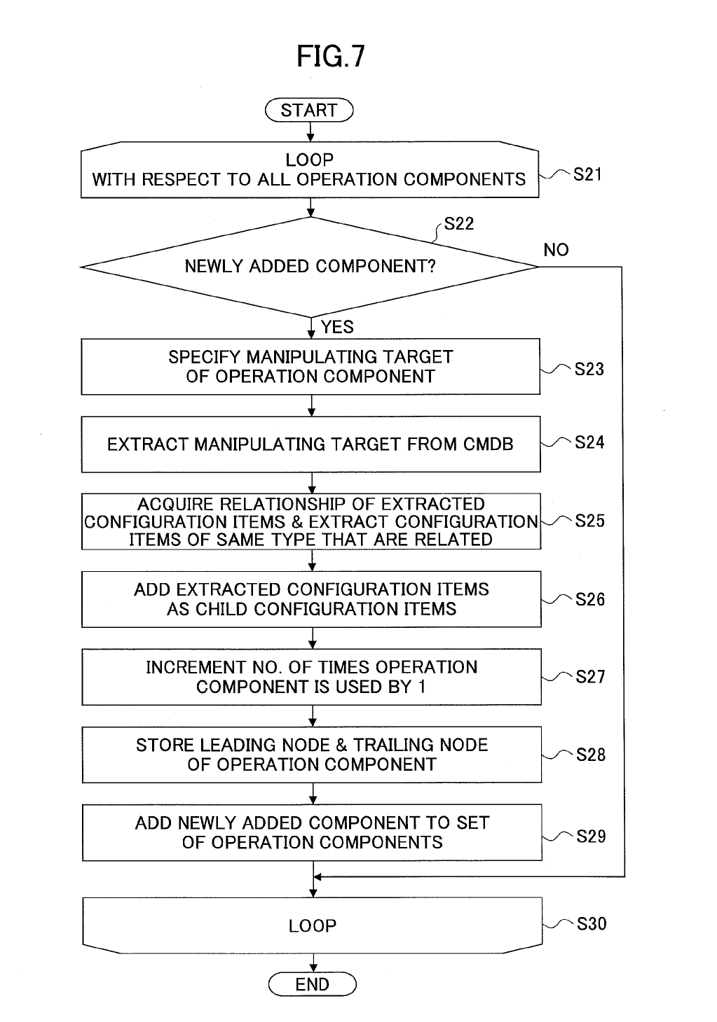

Next, a description will be given of an example of an accumulating process of step S10 described above to accumulate the creation logs of the operation process, by referring to FIG. 7. FIG. 7 is a flow chart for explaining the example of the accumulating process to accumulate creation logs of the operation process. The accumulating process illustrated in FIG. 7 performs a first process to derive the hierarchical structure of the manipulating target from the management server (CMDB) when storing the operation process definition, and a second process to accumulate the creation log when storing the operation process.

More particularly, in the accumulating process illustrated in FIG. 7, processes of steps S21 through S30 are repeated until the process with respect to all operation components of the process definition, included in the operation process after its creation, is completed. In the example illustrated in FIG. 7, the processes of steps S21 through S30 are repeated until the process with respect to all operation components is completed, however, the processes are not limited to such, and for example, the processes may include a process on other components (or nodes).

First, the accumulating process compares the contents at the time of the current storage with the contents at the time of the previous storage, and judges whether a newly added component exists (step S22). When the newly added component exists and the judgment result in step S22 is YES, the accumulating process specifies the manipulating target of the operation component (step S23), and extracts the manipulating target from the CMDB or the like of the management server 12 (step S24).

Next, the accumulating process acquires the relationship (or corresponding relationship) of the configuration items related to the extracted manipulating target, and extracts the configuration items of the same type that are related (step S25). Then, the accumulating process adds the extracted configuration items as child configuration items (step S26). Next, the accumulating process increments the number of times the operation component is used by one (step S27), and stores the leading node and the trailing node with respect to the operation component as the log information of the adjacent nodes (step S28).

Next, the accumulating process adds the newly added component to the set of the operation components, as an operation component usable in correspondence with a process definition name (step S29). In addition, when the target operation component is not a newly added component and the judgment result in step S22 is NO, the accumulating process is performed with respect to the next operation component, by looping back from step S30 to step S21. Accordingly, this embodiment can acquire the creation log information that is used at the time of the next and the subsequent operation process creating processes, by performing the processes described above.

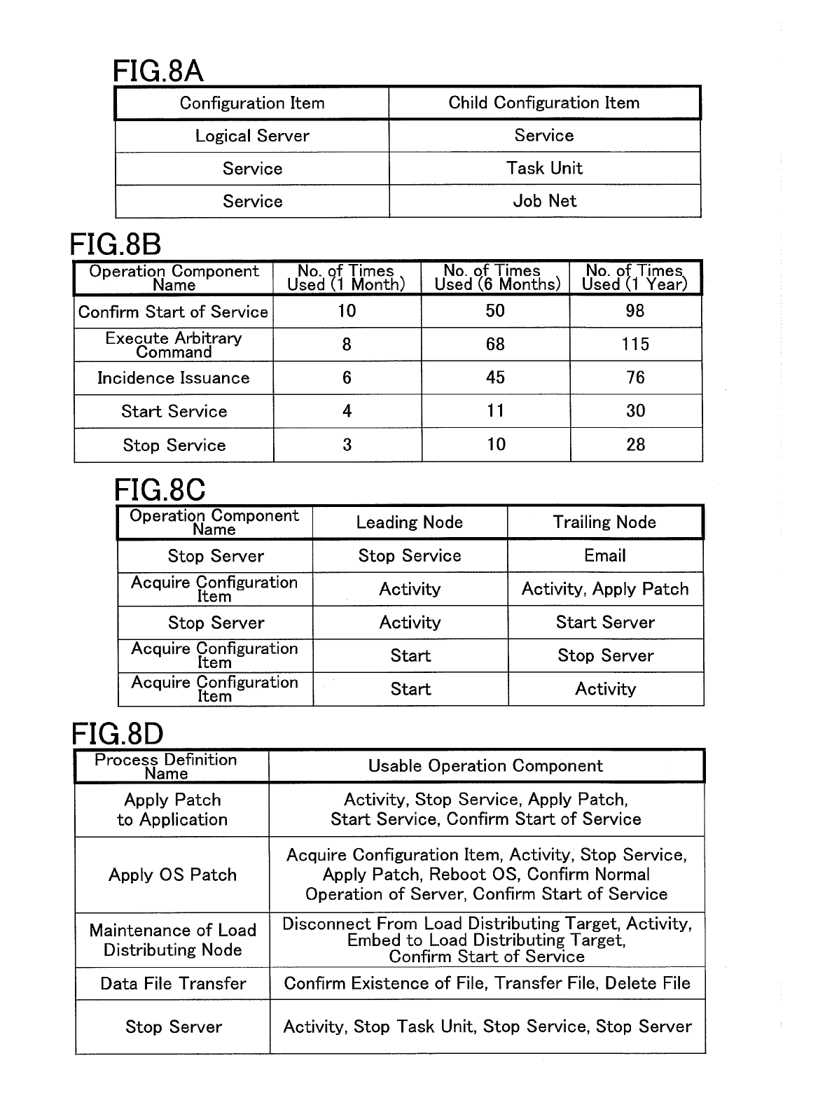

FIGS. 8A through 8D are diagrams illustrating an example of data of the creation logs of the operation process. FIG. 8A illustrates an example of the data of the hierarchical structure of the configuration items, FIG. 8B illustrates an example of the data of the frequency of use of the operation components, FIG. 8C illustrates an example of the data of the log information of the adjacent nodes, and FIG. 8D illustrates an example of the data of the set of operation components.

Items that are related in FIG. 8A are the “configuration item” and the “child configuration item”, however, the data of the hierarchical structure of the configuration items are not limited to such. The data illustrated in FIG. 8A are obtained by the process of step S26 described above, for example.

More particularly, in this embodiment, amongst the configuration items of the operation components that are used at the time of creating the operation process, the configuration items that are related in advance by the relationship are stored as the child configuration items. For example, in the example illustrated in FIG. 8A, the “service” is stored as the child configuration item of a “logical server”, and a “task unit (or work unit)” and a “job net” are stored as child configuration items of the “service”. The task unit refers to a unit of operation of an application, for example. In addition, the job net refers to a collection of one or more jobs in which an order of execution is specified.

Items illustrated in FIG. 8B include “operation component name”, “number of times used (1 month)”, “number of times used (6 months)”, “number of times used (1 year)”, or the like, however, the data of the frequency of use of the operation components are not limited to such. The data illustrated in FIG. 8B are obtained by the process of step S27 described above, for example. More particularly, in the example illustrated in FIG. 8B, in a case in which the operation component name is “confirm start of service”, for example, the number of times used is indicated as 10 times for one month, the number of times used is indicated as 50 times for six months, and the number of times used is indicated as 98 times for one year.

Items illustrated in FIG. 8C include “operation component name”, “leading node”, “trailing node”, or the like, however, the data of the log information of the leading and trailing nodes are not limited to such. The data illustrated in FIG. 8C are obtained by the process of step S28 described above, for example. More particularly, in the example illustrated in FIG. 8C, in a case in which the operation component name is “stop server”, the leading node that is stored is “stop service”, and the trailing node that is stored is “Email”.

Items illustrated in FIG. 8D include “process definition name”, “usable operation component”, or the like, however, the data of the set of operation components are not limited to such. The data illustrated in FIG. 8D are obtained by the process of step S29 described above, for example. More particularly, in the example illustrated in FIG. 8D, in a case in which the process definition name is “apply patch of application”, the usable operation components, such as “activity”, “stop service”, “apply patch”, “start service”, “confirm start of service”, or the like are stored. The usable operation component indicates the operation component that is usable for each process definition, for example. In this embodiment, the information described above can be used to estimate the node, such as the next operation component, from the operation process that is being created.

### Embodiments of Process of Estimating Operation Component From Operation Process Being Created

Next, a description will be given of particular embodiments of the process of estimating the operation component from the operation process that is being created.

### Practical Example Emb1

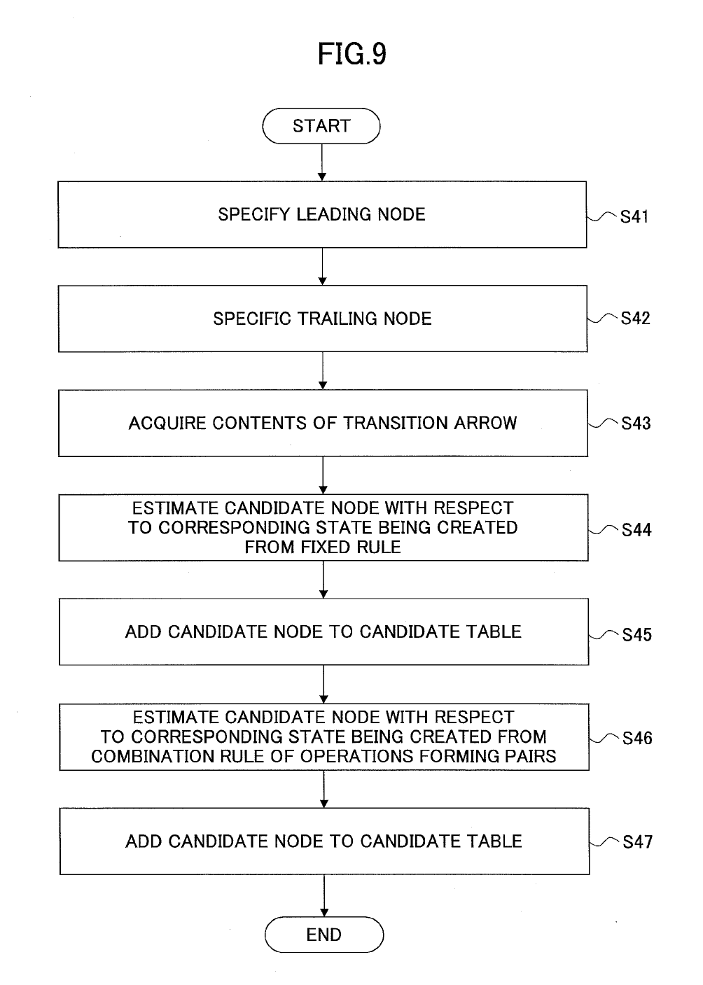

FIG. 9 is a flow chart for explaining an example of an estimating process in a practical example Emb1. This practical example Emb1 represents an example of the candidate estimating process using the fixed rule described above and the operation pair described above. First, in the operation process being created, the estimating process in this practical example Emb1 specifies the leading node from the nodes that are already definite (step S41). In the process of step S41, the position of the cursor displayed on the screen is used as a reference, for example, and the node that is arranged to the left side and to the upper side of the cursor is regarded as the leading node. Next, the estimating process in this practical example Emb1 specifies the trailing node (step S42). In the process of step S42, the node that is arranged to the right side and to the lower side of the cursor displayed on the screen, for example, is regarded as the trailing node.

Next, the estimating process in this practical example Emb1 acquires contents of the transition arrow (or linking line) linking the leading node and the trailing node (step S43), and estimates a candidate node with respect to the state that is being created using the fixed rule that is preset (step S44). In the process of step S43, the contents of the transition arrow are acquired from an originating source and a name of the arrow extending from the leading node, for example. In addition, in the process of step S44, the trailing candidate node corresponding to the state that is currently being created is estimated by comparing the leading node and the contents (state being created) of the transition arrow with the data illustrated in FIG. 5 described above. The estimating process in this practical example Emb1 adds the estimated candidate node to the candidate table or the like (step S45).

Next, the estimating process in this practical example Emb1 estimates the candidate node with respect to the state that is being created, from the combination rule of the operations forming pairs as illustrated in FIG. 6 described above (step S46). Thereafter, the estimating process in this practical example Emb1 adds the candidate node to the candidate table (step S47), and the estimating process ends.

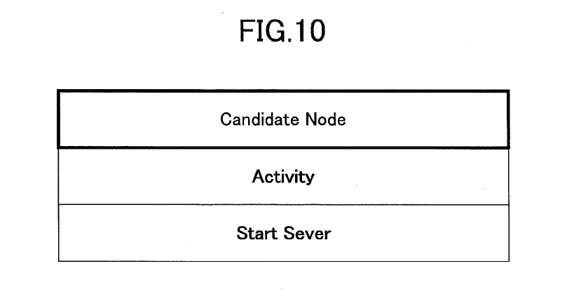

FIG. 10 is a diagram illustrating an example of the candidate table in the practical example Emb1. In this embodiment, a plurality of candidate nodes are stored in a predetermined order in the candidate table illustrated in FIG. 10, by the estimating process illustrated in FIG. 9 described above, and the contents of the candidate table are displayed at a predetermined position on the screen, such as in the pallet, for example. The candidate table may be stored in the storing unit 23 or the like.

The estimating process in this practical example Emb1 successively performs estimation of the candidate node from the fixed rule and the estimation of the candidate node from the operation pair, however, the estimating process is not limited to such, and the estimation may be performed separately. In this case, the estimating process to estimate the candidate node from the fixed rule may perform the processes of steps S41 through S45, for example, and the estimating process to estimate the candidate node from the operation pair may perform the process of step S41 and thereafter perform the processes of steps S46 and S47.

### Practical Example Emb2

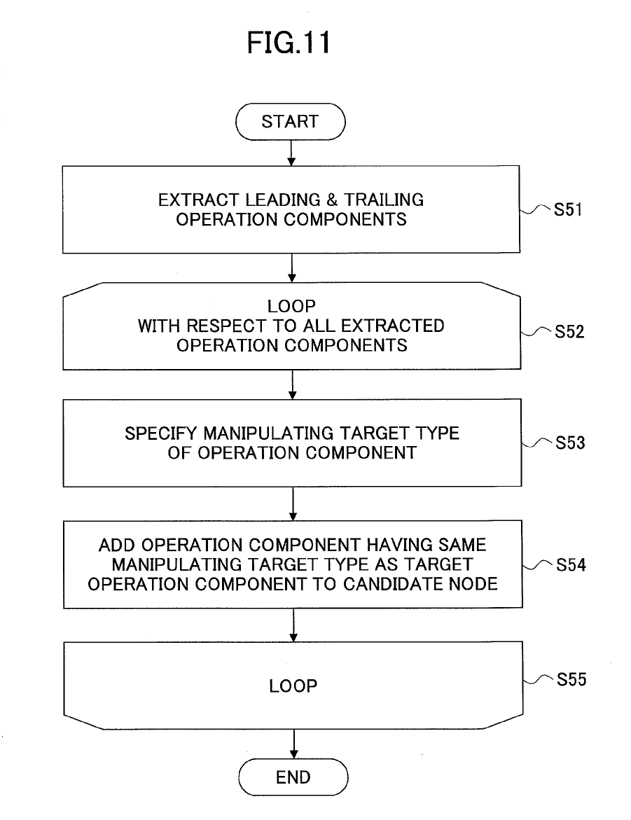

FIG. 11 is a flow chart for explaining an example of the estimating process in a practical example Emb2. This practical example Emb2 represents an example of the candidate estimating process using successive manipulations with respect to the same target.

The estimating process in this practical example Emb2 extracts the leading and trailing operation components, for example (step S51), and thereafter repeats the processes (or loop) of steps S52 through S55 until the processes with respect to all of the extracted operation components end. The process of step S51 extracts, as the leading operation component, the operation component that is arranged in a predetermined direction (that is, in at least one preset direction amongst upper, lower, right, and left directions) with respect to the position information of the cursor on the screen, for example.

The estimating process in this practical example Emb2 specifies the manipulating target type of the target, leading operation component, for example (step S53). The manipulating target type can be specified by presetting setting information of the manipulating target type in advance with respect to each of the operation components, and referring to the preset setting information. The setting information may be stored in the storing unit 23, for example. In addition, the estimating process in this practical example Emb2 adds the operation component having the same manipulating target type as the target operation component to the candidate node (step S54). The process of step S54 may add the candidate node to the candidate table described above, for example. The estimating process illustrated in FIG. 11 is not limited to the process with respect to the operation components, and the process may be performed with respect to the nodes having other components.

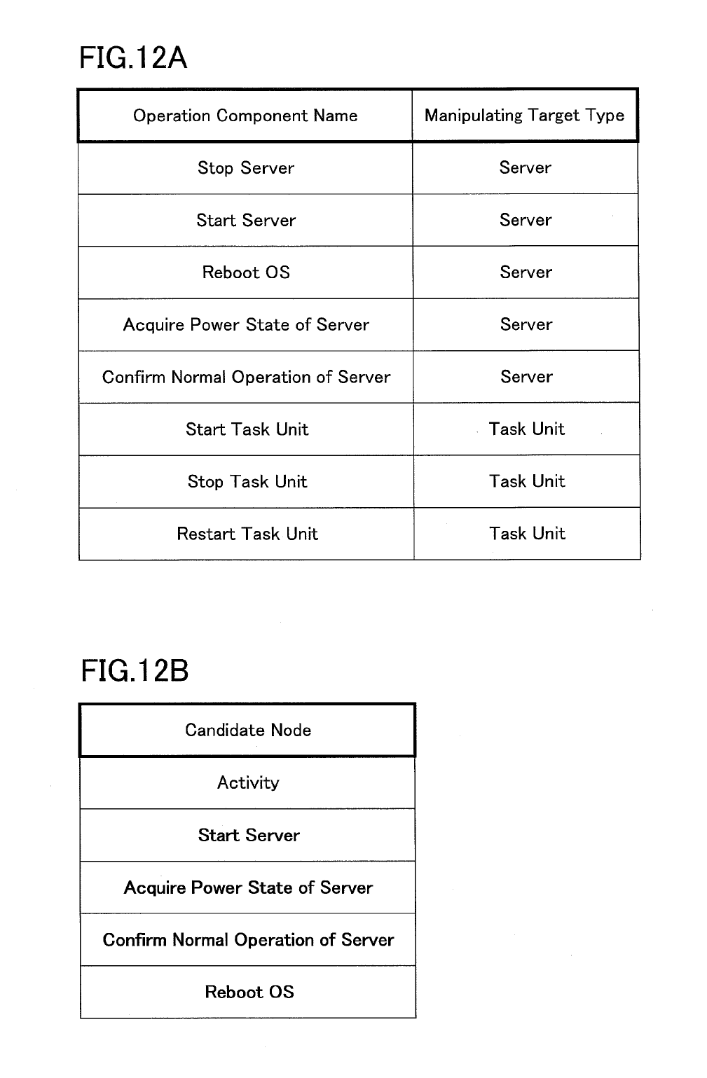

FIGS. 12A and 12B are diagrams illustrating an example of data corresponding to the estimating process in the practical example Emb2. FIG. 12A illustrates an example of the manipulating target types, and FIG. 12B illustrates an example of the candidate table in the practical example Emb2. In FIG. 12A, the manipulating target type is set in correspondence with each operation component name, however, the contents, the type, or the like are not limited to those illustrated in FIG. 12A. For example, the manipulating target type is “server” for each of the cases in which the operation component name is “stop server”, “start server”, “reboot OS”, “acquire power state of server”, and “confirm normal operation of server”. Hence in this embodiment, by presetting the manipulating target type corresponding to the operation component name, in a case in which the leading node is “stop server”, for example, the operation component having the same manipulating target type as the target operation component can be obtained as the candidate node by referring to the manipulating target types illustrated in FIG. 12A. Accordingly, in this embodiment, it is possible to collectively provide the operation components having the same manipulating target type, as illustrated in FIG. 12B.

### Practical Example Emb3

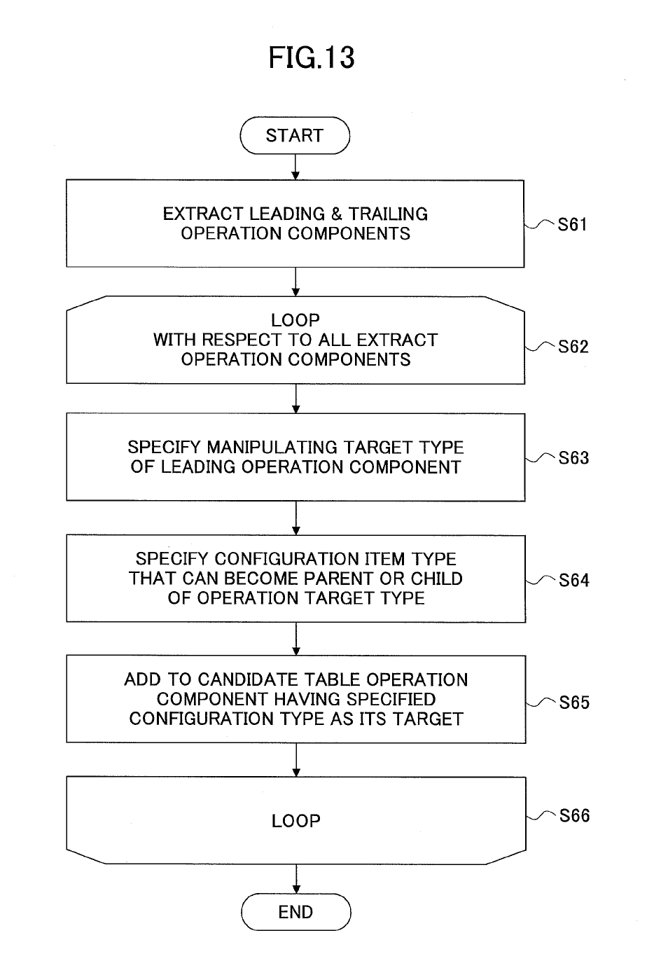

FIG. 13 is a flow chart for explaining an example of the estimating process in a practical example Emb3. This practical example Emb3 represents an example of the candidate estimating process based on the hierarchical structure. The estimating process in this practical example Emb3 extracts the leading and trailing operation components, for example (step S61), and thereafter repeats the processes (or loop) of steps S62 through S66 until the processes with respect to all of the extracted operation components end. The process of step S61 extracts, as the leading operation component, the operation component that is arranged in a predetermined direction (that is, in at least one preset direction amongst upper, lower, right, and left directions) with respect to the position information of the cursor on the screen, for example.

The estimating process in this practical example Emb3 specifies the manipulating target type of the leading target operation component (step S63), and specifies the configuration item type that can become the parent or the child of the operation target type (step S64). The process of step S64 may specify the configuration item type having the parent-child hierarchical structure using the information illustrated in FIG. 8A, for example. Next, the estimating process in this practical example Emb3 adds, to the candidate table, the operation component having the specified configuration item type as its target (step S65).

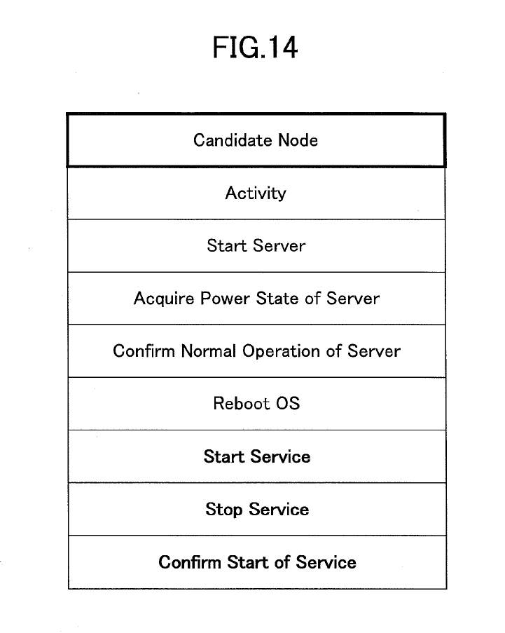

FIG. 14 is a diagram illustrating an example of the candidate table in the practical example Emb3. This practical example Emb3 may perform the estimating process illustrated in FIG. 13, and estimate one or a plurality of candidate nodes illustrated in FIG. 14. For example, in FIG. 8A described above, the “service” is a child configuration item of the “logical server”. Accordingly, this practical example Emb3, when applied with the hierarchical structure illustrated in FIG. 8, one or a plurality of candidate nodes of the services (or children) can be stored under the candidate node with respect to the server (or parent), as illustrated in the candidate table of FIG. 14. In the example illustrated in FIG. 14, candidate nodes of the lower (child) hierarchical layers, such as “start service”, “stop service”, and “confirm start of service” are added.

### Practical Example Emb4

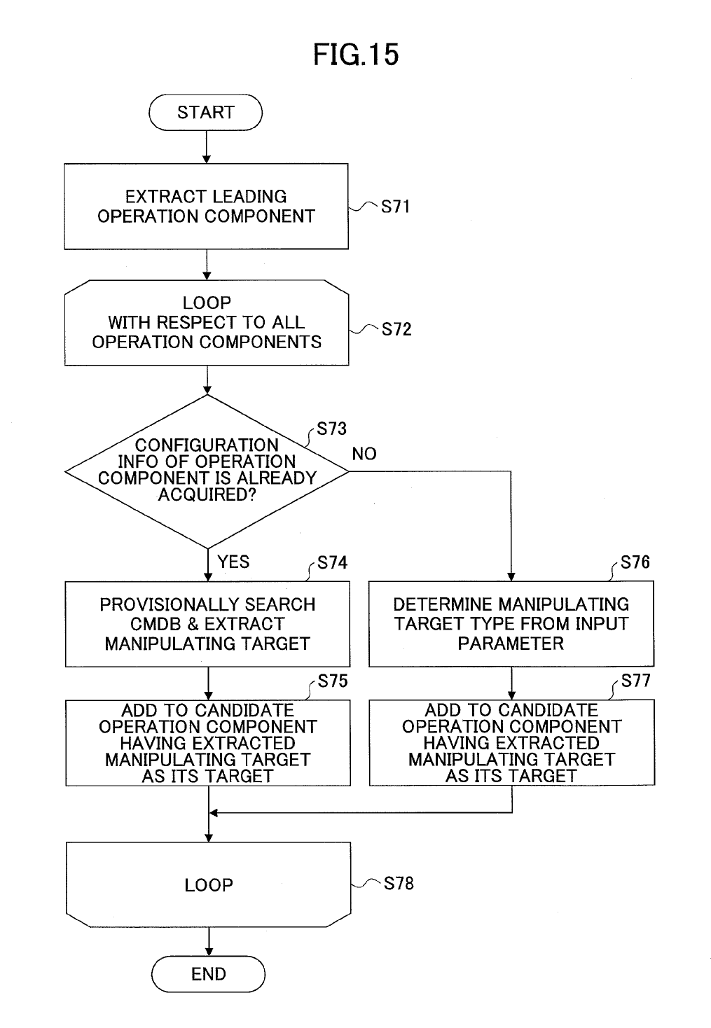

FIG. 15 is a flow chart for explaining an example of the estimating process in a practical example Emb4. This practical example Emb4 represents an example of the candidate estimating process that estimates the operation component from the manipulating target type. The estimating process in this practical example Emb4 first extracts the leading operation component (step S71), and thereafter repeats the processes (or loop) of steps S72 through S78 until the processes with respect to all of the extracted operation components end. The process of step S71 extracts, as the leading operation component, the operation component that is arranged in a predetermined direction (that is, in at least one preset direction amongst upper, lower, right, and left directions) with respect to the position information of the cursor on the screen, for example.

The estimating process in this practical example Emb4 judges whether the configuration information of the operation component is already acquired (step S73). In other words, the process of step S73 judges whether the configuration information of the operation component is already acquired, only with respect to the leading node whose arrangement is already definite. In a case in which the configuration information of the operation component is already acquired (YES in step S73), the manipulating target is extracted by provisionally searching the CMDB or the like provided in the management server 12, for example (step S74). In addition, the estimating process in this practical example Emb4 adds to the candidate the operation component having the extracted manipulating target as its target (step S75).

On the other hand, in the estimating process in this practical example Emb4, in a case in which the configuration information of the operation component is not already acquired (NO in step S73), the manipulating target type is determined from a preset input parameter or the like, for example (step S76). In addition, the estimating process in this practical example Emb4 adds to the candidate the operation component having the determined manipulating target type as its target (step S77). The processes of steps S75 and S77 may add the operation component to the candidate table, for example.

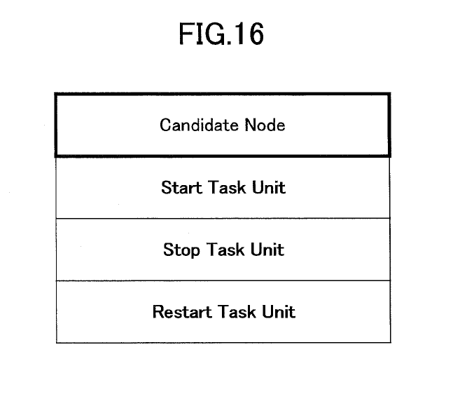

FIG. 16 is a diagram illustrating an example of the candidate table in the practical example Emb4. In a case in which the operation component of the leading node is the operation component whose configuration information (that is, configuration item) is acquired, suppose that the estimating process in this practical example Emb4 specifies a task unit as the manipulating target from the results of the provisional search using the CMDB or the like. In this case, the estimating process in this practical example Emb4 stores in the candidate table, as the candidate nodes, one or a plurality of preset operation components having the task unit as the target. In the example illustrated in FIG. 16, “start task unit”, “stop task unit”, and “restart task unit” are stored as the candidate nodes, however, the candidate nodes are not limited to such.

### Practical Example Emb5

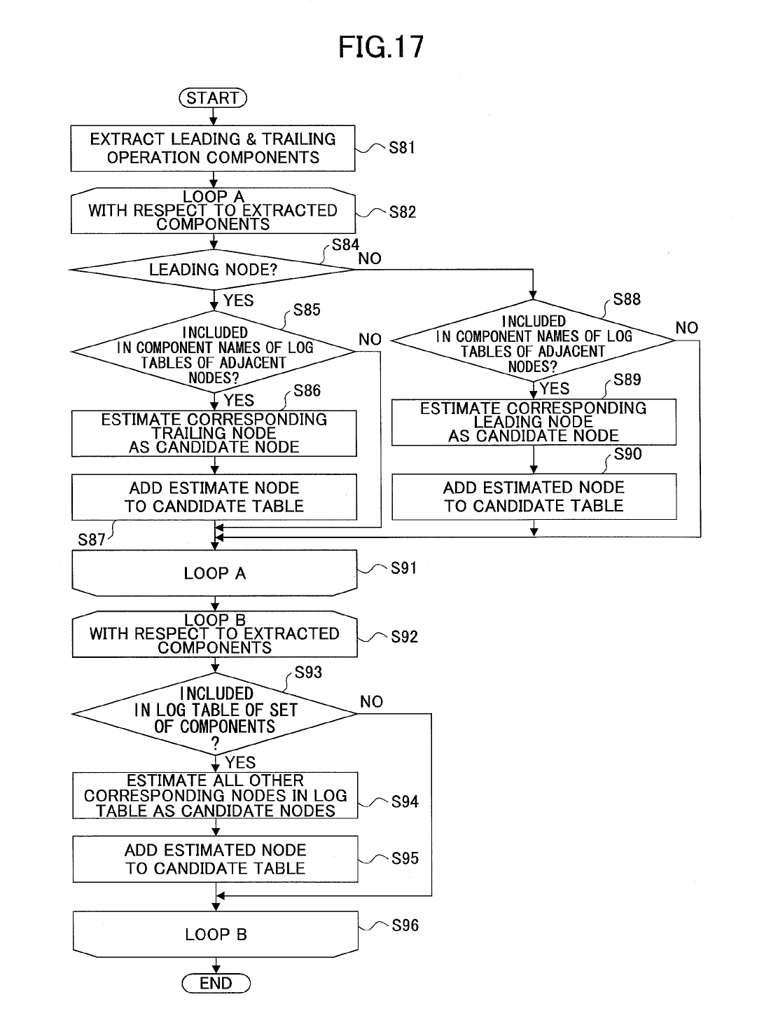

FIG. 17 is a flow chart for explaining an example of the estimating process in a practical example Emb5. This practical example Emb5 represents an example of the candidate estimating process that estimates the operation component from the past creation logs. For example, as an example of estimating the operation component from the past creation logs, this practical example Emb5 may estimate the candidate from leading and trailing relationships of the operation component, or estimate the candidate from a set of operation components.

The estimating process in this practical example Emb5 first extracts the leading and trailing operation components (step S81). The process of step S81 extracts, as the leading operation component, the operation component that is arranged in a predetermined direction (that is, in at least one preset direction amongst upper, lower, right, and left directions) with respect to the position information of the cursor on the screen, for example.

Next, the estimating process in this practical example Emb5 repeats the processes (or loop A) of steps S82 through S91 until the processes with respect to all of the extracted operation components end. In addition, after the processes of steps S82 through S91 end, the estimating process in this practical example Emb5 repeats the processes (or loop B) of steps S92 through S96 until the processes with respect to all of the extracted operation components end.

The estimating process in this practical example Emb5 judges whether the processing target node is the leading node (step S84). When the processing target node is the leading node (YES in step S84), the estimating process in this practical example Emb5 judges whether the components of the leading node are included in the component names of log tables of the adjacent nodes (step S85). When the components of the leading node are included in the component names of the log tables (YES in step S85), the estimating process in this practical example Emb5 estimates the trailing node corresponding to the leading node as the candidate node (step S86), and adds the estimated candidate node to the candidate table (step S87). In addition, when the components of the leading node are not included in the component names of the log tables (NO in step S85), the estimating process in this practical example Emb5 does not perform any process and the process advances to step S91 for the loop A.

On the other hand, when the processing target node is not the leading node (NO in step S84), the processing target node is the trailing node, and thus, the estimating process in this practical example Emb5 judges whether the trailing node, which is the processing target node, is included in the component names of the log tables of the adjacent nodes (step S88). In addition, when the trailing node is included in the component names of the log tables (YES in step S88), the estimating process in this practical example Emb5 estimates the leading node corresponding to the trailing node as the candidate node (step S89), and adds the estimated candidate node to the candidate table (step S90). Further, when the components of the trailing node are not included in the component names of the log tables (NO in step S88), the estimating process in this practical example Emb5 does not perform any process and the process advances to step S91 for the loop A. The log tables of the adjacent nodes may be formed by tables including the data illustrated in FIG. 8C, for example, but are not limited to such.

Next, the estimating process in this practical example Emb5 judges whether the components of the processing target are included in log table of a preset set of components (step S93), as a process of the loop B. When the components of the processing target are included in the log table of the set of components (YES in step S93), the estimating process in this practical example Emb5 estimates all other corresponding nodes in the log table as the candidate nodes (step S94). In addition, the estimating process in this practical example Emb5 adds the estimated candidate nodes to the candidate table (step S95). When the components of the processing target are not included in the log table of the set of components (NO in step S93), the estimating process in this practical example Emb5 does not perform any process and the process advances to step S96 for the loop B. The log table of the set of components may be formed by a table including the data illustrated in FIG. 8D, for example, but are not limited to such.

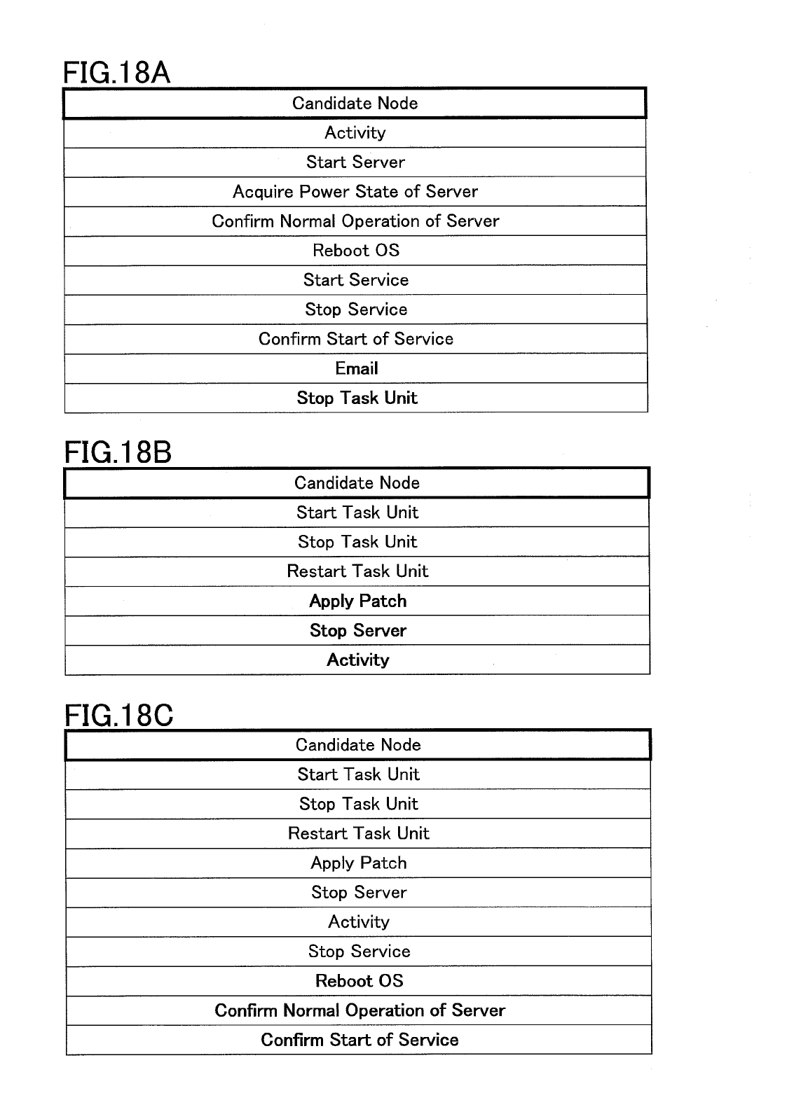

FIGS. 18A through 18C are diagrams illustrating examples of the candidate table in the practical example Emb5. FIG. 18A illustrates an example of the candidate node estimated from the adjacent relationship of the operation components and the set of operation components. FIG. 18B illustrates an example of the candidate node estimated from the adjacent relationship of the operation components. FIG. 18C illustrates an example of the candidate node estimated from the set of operation components.

In this practical example Emb5, it is possible to provide the user with the appropriate, different candidate nodes according to the respective conditions, as illustrated in FIGS. 18A through 18C, by performing the estimating process illustrated in FIG. 17. In addition, this practical example Emb5 can acquire the candidate tables illustrated in FIGS. 18A through 18C that are obtained under a plurality of preset conditions, and display each of the acquired candidate tables on the screen. In this case, the plurality of candidate tables may be displayed at different positions on the screen, or one of the plurality of candidate tables may be displayed at one time such that each of the plurality of candidate tables is repeatedly displayed at predetermined time intervals.

### Practical Example Emb6

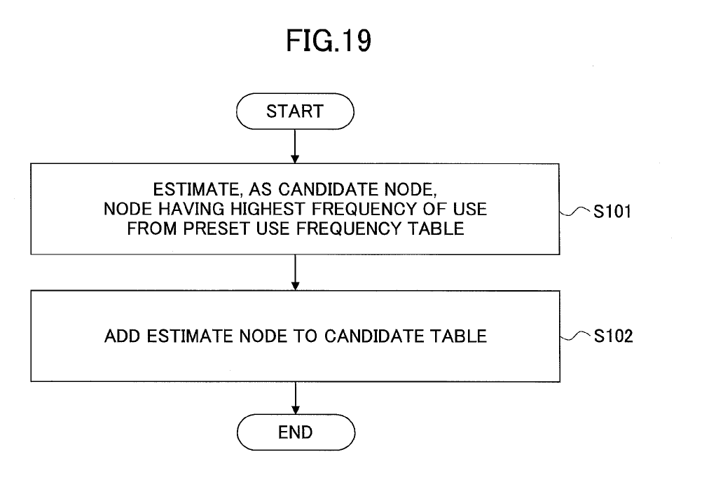

FIG. 19 is a flow chart for explaining an example of the estimating process in a practical example Emb6. This practical example Emb6 represents an example of the candidate estimating process that estimates the candidate node from the number of times the operation component is used.

The estimating process in this practical example Emb6 first estimates, as the candidate node, the node having a highest frequency of use (largest number of times used) from a preset use frequency table (step S101), and adds the estimated candidate not to the candidate table (step S102). The use frequency table may be formed by a table including the data illustrated in FIG. 8B, for example, but are not limited to such. The frequency of use of the node may use a predetermined time period (for example, 1 month, 6 months, 1 year, etc.) as a reference.

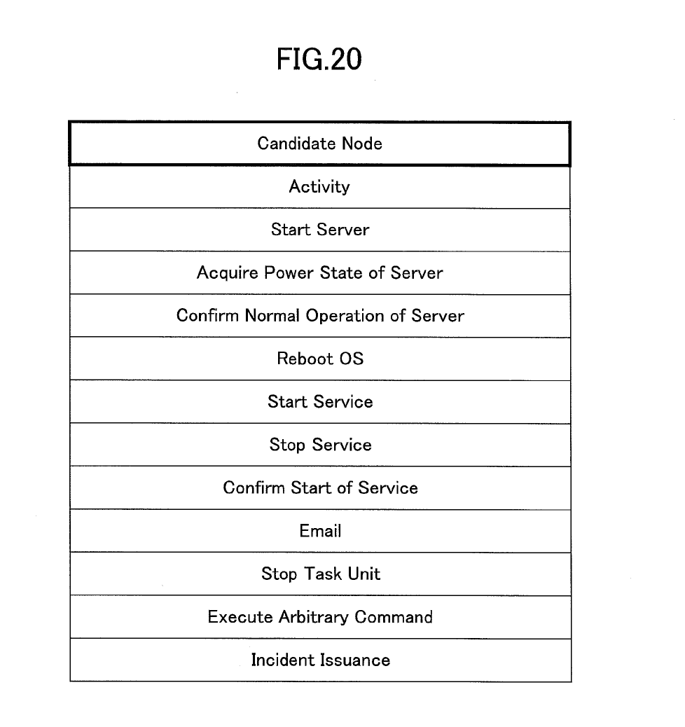

FIG. 20 is a diagram illustrating an example of the candidate table in the practical example Emb6. One or a plurality of candidate nodes can be provided to the user, as illustrated in FIG. 20, by performing the estimating process illustrated in FIG. 19, for example. In the example illustrated in FIG. 20, candidate nodes “activity”, “start server”, “acquire power state of server”, “confirm normal operation of server”, “reboot OS”, “start service”, “stop service”, “confirm start of service”, “Email”, “stop task unit”, “execute arbitrary command”, and “issue incident” are stored in the candidate table in this order.

The estimating process in this embodiment is not limited to those of the practical examples Emb1 through Emb6 described above. For example, two or more practical examples may be combined to perform the estimating process to estimate the candidate node.

<Number of Candidate Nodes>

In the example illustrated in FIG. 20, twelve (12) candidate nodes are provided. However, the number of candidate nodes that are provided is is not limited to twelve (12), and the number of candidate nodes may be adjusted according to the size or the like of the pallet of the candidate nodes displayed on the screen, for example. A predetermined number of candidate nodes having high priorities may be displayed in the pallet, starting from the candidate table having the highest priority.

<Example of Screen Displaying Candidate Nodes (Example of Pallet)>

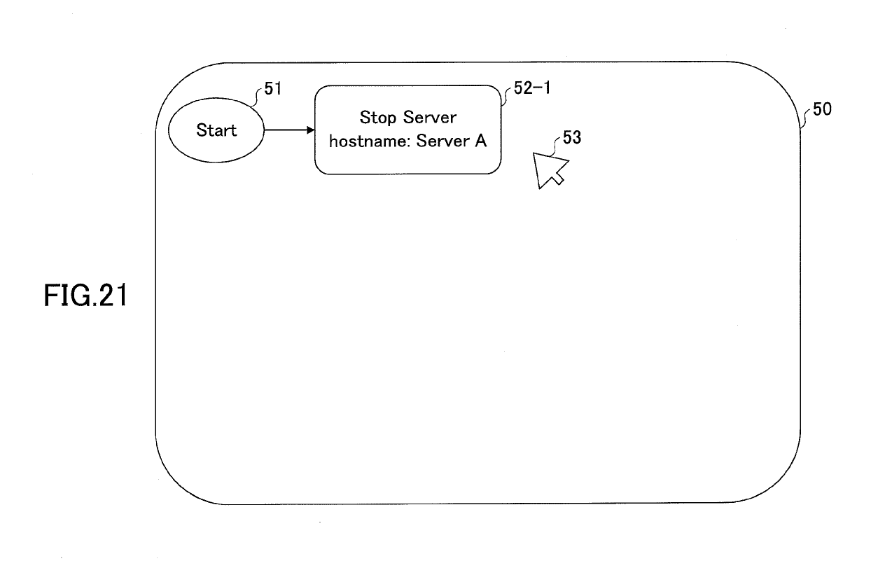

Next, a description will be given of an example of the screen displaying the candidate nodes estimated by each of the practical embodiments Emb1 through Emb6 described above, by referring to FIGS. 21 through 23. FIGS. 21 through 23 are diagrams illustrating an example of the display screen in an operation process creating environment in one embodiment.

FIG. 21 illustrates an operation process creating screen 50, as an example of an operation process creating editor. FIG. 21 illustrates a state in which a start component 51 is fired arranged in the operation process creating screen 50, and a “stop server (hostname: server A)” component 52-1 is thereafter arranged in the operation process creating screen 50.

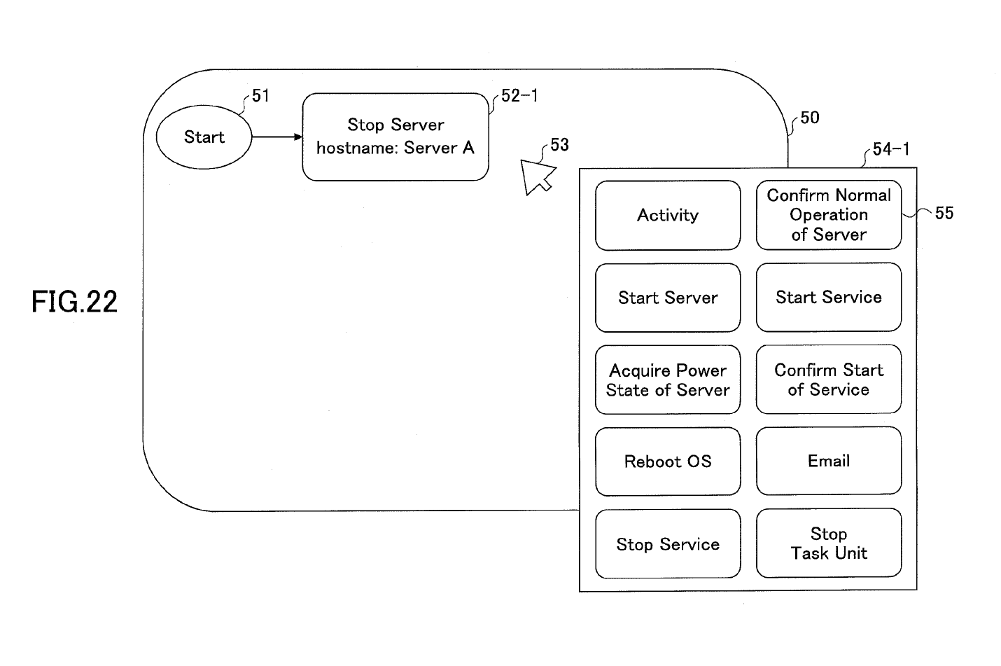

In this case, this embodiment displays the candidate node trailing the component 52-1 on the operation process creating screen 50. More particularly, using the current position information of a cursor 53 on the operation process creating screen 50 as a reference, a pallet 54-1 in which the candidate nodes are arranged is displayed on the operation process creating screen 50 in a vicinity of the cursor 53, as illustrated in FIG. 22. The cursor 53 is a kind of a pointer that is displayed in the display region of the screen, including the operation process creating screen 50, and determines a positional move or a position when manipulated by the user. However, various kinds of pointers, other than the cursor 53, may be used to determine the positional move or the position when manipulated by the user.

In this embodiment, the pallet 54-1 may be displayed so as not to conceal the component (for example, the component that is arranged last) that is displayed using the position information of the already definite components 51 and 52-1 as a reference. In addition, the display position of the pallet 54-1 may be set based on both the position information of the cursor 53 and the position information of the components 51 and 52-1. Accordingly, this embodiment can shorten the distances amongst the arranging position of the trailing node, the cursor 53, and the pallet 54-1, and enable the user to select and arrange the next component by a simple operation. Thus, this embodiment can reduce the time required to create the operation process.

The estimating process of any of the practical examples Emb1 through Emb6 may be performed using, as the leading node, the component 52-1 whose arrangement is already definite, and enable the user to acquire the appropriate candidate node. In the example illustrated in FIG. 22, the candidate node may be acquired according to the state (for example, abnormal, approved, rejected, etc.) or the like of the transition arrow (or linking line) linking the component 51 and the component 52-1. In this case, the contents (or meaning) of the transition arrow are displayed on the operation process creating screen 50, and the contents of the transition arrow can be acquired from the displayed contents.

In addition, the number of candidate nodes 55 arranged in the pallet 54-1 is not limited to a particular number. However, the number of candidate nodes arranged in the pallet 54-1 is preferably on the order of ten (10), for example, and the number may be adjusted according to the screen size or the like.

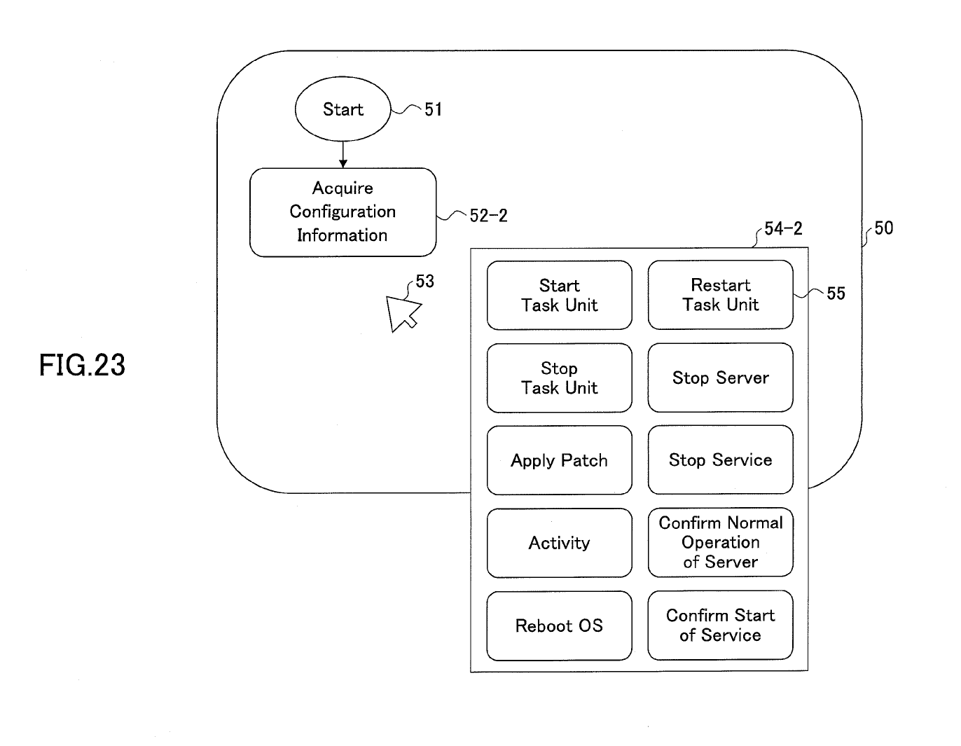

In this embodiment, in a case in which the “acquire configuration information” component 52-2 is arranged to trail the start component 51 as illustrated in FIG. 23, for example, the estimating process described above estimates candidate nodes 55 using the component 52-2 as the leading node. In addition, a predetermined number of the estimated candidate nodes 55 is arranged in a pallet 54-2 in a predetermined order, and as described above, the pallet 54-2 is displayed on the operation process creating screen 50 using, as the reference, the position of the cursor 53 or the positions of the components 51 and 52-2 whose arrangements are already definite. Hence, by performing the estimating process described above to estimate the candidate nodes, this embodiment can provide the user with the appropriate, different nodes, as the candidate nodes, and the pallets 54-1 and 54-2 can be displayed at appropriate positions easily manipulated by the user, as illustrated in FIGS. 22 and 23. Therefore, the user may move the cursor 53 from the candidate node 55 displayed in the pallets 54-1 and 54-2 illustrated in FIGS. 22 and 23 and select the trailing node, in order to quickly arrange the selected trailing node at a predetermined position on the operation process creating screen 50.

In the examples illustrated in FIGS. 21 through 23, the components (or nodes) are displayed in the operation process creating screen 50 in the form of an icon, a name, or the like set for each of the nodes. However, the nodes that are displayed in the operation process creating screen 50 may be displayed in other forms, such the form of a symbol, a pattern, a mark, a character string, or the like set for each of the nodes. In this embodiment, because a pop-up display of the pallet can be made at the predetermined position on the editor, it is easy for the user to select the operation component, and as a result, this embodiment can greatly reduce the time required to create the operation process.

As described above, this embodiment can quickly create the operation process. Hence, this embodiment can greatly reduce the cost required to create the operation process.

This embodiment may be applied to the fields such as the smart technology or the like, for example. The smart technology refers to an optimization technology that self-judges the states of the hardware and software, in order to enable simple and safe use of the hardware and software. More particularly, the smart technology may autonomously make a prediction based on relationships of the operation components, however, the smart technology is not limited to such. In addition, this embodiment can be applied to software SRA (System Walker Runbook Automation) manufactured by Fujitsu Limited, or the like, but the application of this embodiment is not limited to such.

Although the practical examples are numbered with, for example, “Emb1,” “Emb2,” . . . “Emb6,” the ordinal numbers do not imply priorities of the practical examples. Many other variations and modifications of the embodiments and the practical examples will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium having stored therein an operation process creating program that causes a computer to execute a process comprising:
estimating trailing candidate nodes with respect to a node whose arrangement is definite, using at least one of a preset process definition, a type of node that is a manipulating target, and past creation logs of processes performed in past to create operation processes, when arranging a plurality of nodes on a screen of a display unit and creating the operation process;
generating a display region in which a number of candidate nodes are displayed in an order, amongst the candidate nodes that are estimated; and
displaying the display region that is generated at a position on the screen of the display unit.

2. The non-transitory computer-readable storage medium as claimed in claim 1, wherein the estimating estimates the candidate nodes using at least one of information in which candidate nodes are set in correspondence with states during creation of the operation process, combination information of operation pairs, information of successive manipulations on a single target, and information of a hierarchical structure of the manipulating target.

3. The non-transitory computer-readable storage medium as claimed in claim 1, wherein the estimating estimates the candidate nodes using contents of a transition arrow linking two nodes.

4. The non-transitory computer-readable storage medium as claimed in claim 1, wherein the displaying sets the position on the screen where the display region is displayed, based on position information of a pointer displayed on the screen.

5. The non-transitory computer-readable storage medium as claimed in claim 1, wherein the displaying sets the position on the screen where the display region is displayed, based on position information of one or more nodes when the one or more nodes are arranged on the screen.

6. An operation process creating method comprising:
estimating, by a processor, trailing candidate nodes with respect to a node whose arrangement is definite, using at least one of a preset process definition, a type of node that is a manipulating target, and past creation logs of processes performed in past to create operation processes, when arranging a plurality of nodes on a screen of a display unit and creating an operation process;
generating, by the processor, a display region in which a number of candidate nodes are displayed in an order, amongst the candidate nodes that are estimated; and
displaying the display region that is generated at a position on the screen of the display unit.

7. The operation process creating method as claimed in claim 6, wherein the estimating estimates the candidate nodes using at least one of information in which candidate nodes are set in correspondence with states during creation of the operation process, combination information of operation pairs, information of successive manipulations on a single target, and information of a hierarchical structure of the manipulating target.

8. The operation process creating method as claimed in claim 6, wherein the estimating estimates the candidate nodes using contents of a transition arrow linking two nodes.

9. The operation process creating method as claimed in claim 6, wherein the displaying sets the position on the screen where the display region is displayed, based on position information of a pointer displayed on the screen.

10. The operation process creating method as claimed in claim 6, wherein the displaying sets the position on the screen where the display region is displayed, based on position information of one or more nodes when the one or more nodes are arranged on the screen.

11. An information processing apparatus comprising:
a processor configured to create an operation process by executing a process including
estimating trailing candidate nodes with respect to a node whose arrangement is definite, using at least one of a preset process definition, a type of node that is a manipulating target, and past creation logs of processes performed in past to create operation processes, when arranging a plurality of nodes on a screen and creating an operation process;
generating a display region in which a number of candidate nodes are displayed in an order, amongst the candidate nodes that are estimated; and
displaying the display region that is generated at a position on the screen.

12. The information processing apparatus as claimed in claim 11, wherein the estimating estimates the candidate nodes using at least one of information in which candidate nodes are set in correspondence with states during creation of the operation process, combination information of operation pairs, information of successive manipulations on a single target, and information of a hierarchical structure of the manipulating target.

13. The information processing apparatus as claimed in claim 11, wherein the estimating estimates the candidate nodes using contents of a transition arrow linking two nodes.

14. The information processing apparatus as claimed in claim 11, wherein the displaying sets the position on the screen where the display region is displayed, based on position information of a pointer displayed on the screen.

15. The information processing apparatus as claimed in claim 11, wherein the displaying sets the position on the screen where the display region is displayed, based on position information of one or more nodes when the one or more nodes are arranged on the screen.
